(19) United States
(12) Patent Application Publication
(10) Pub. No.: US 2003/0045276 A1
(43) Pub. Date: Mar. 6, 2003

(54) Communication network and method for enabling a mobile feature on a land line element

(76) Inventors: William Michael Bondy, Buffalo Grove, IL (US); Wiliam Frederick Dyer, Cary, IL (US); Wesley Stuart Jones, Palatine, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 09/941,274

(22) Filed: Aug. 28, 2001

(51) Int. Cl. H04M 3/42

(52) U.S. Cl. 455/419; 455/414; 455/435

(57) ABSTRACT

In accordance with the preferred embodiments of the present invention, a communication network (110) and a method (600) for enabling a mobile feature on a land line element are described herein. The communication network (110) generally includes a home subscriber server (240), a services client element (220), and a database translation feature server (230). The home subscriber server (240) being operable to provide mobile feature information. The services client element (220) is coupled for communication with the home subscriber server (240) to retrieve mobile feature information based on a registration associated with a subscriber. The database translation feature server (230) is coupled for communication with the services client element (220) to receive the mobile feature information. Furthermore, the database translation feature server (230) is operable to transmit the mobile feature information to a land line element (250).

### FIELD OF THE INVENTION

The present invention relates generally to communication networks, and more particularly, to a communication network, an apparatus, and a method for enabling a mobile feature on a land line element.

### BACKGROUND OF THE INVENTION

A wireless communication system is a complex network of systems and elements. Typical elements include (1) a radio link to the mobile stations (e.g., cellular telephones), which is usually provided by at least one and typically several base stations, (2) communication links between the base stations, (3) a controller, typically one or more base station controllers or centralized base station controllers (BSC/CBSC), to control communication between and to manage the operation and interaction of the base stations, (4) a call controller or switch, typically a call agent (i.e., a “softswitch”) for routing calls within the system, and (5) a link to the land line or public switch telephone network (PSTN), which is usually also provided by the call agent.

One aspect of designing a wireless communication system is to provide location-based features such as, but not limited to, call forwarding. In particular, call forwarding service is supported by location-based information so that a call may be redirected from a destination originally intended to a different destination. For example, a subscriber may choose to have calls forwarded to an office number or a home number when a mobile station used by the subscriber is busy and registered within a home network. The subscriber may also choose to have calls forwarded to an alternate number when the subscriber is roaming (i.e., registered in a remote location). Furthermore, call forwarding service includes three types: call forwarding unconditional, call forwarding busy, and call forwarding no answer. Call forwarding unconditional provides service that redirects all calls originally intended for the subscriber's number to an alternate number. Call forwarding busy provides similar service to that of call forwarding unconditional but only if the subscriber's number is busy. Call forwarding no answer provides service that alerts the subscriber for a specific length of time before redirecting the unanswered call to different number. Typically, land line communication systems may provide land line (fixed) features such as call forwarding unconditional and call forwarding busy. However, land line communication systems do not support location-based features or other mobile features provided by wireless communication systems. Therefore, a need exists for a communication network and a method for enabling a mobile feature such as call forwarding on a land line element.

### BRIEF DESCRIPTION OF THE DRAWINGS

FIG. 1 is a block diagram representation of a wireless communication system that may be adapted to operate in accordance with the preferred embodiments of the present invention.

FIG. 2 is a block diagram representation of a communication network that may be adapted to operate in accordance with the preferred embodiments of the present invention.

FIG. 3 is a schematic diagram representation of a provisioning database that may be adapted to operate in accordance with the preferred embodiments of the present invention.

FIG. 4 is a schematic diagram representation of a home subscriber server and a provisioning database that may be adapted to operate in accordance with the preferred embodiments of the present invention.

FIG. 5 is a block diagram representation of a communication network that may be adapted to operate in accordance with an alternate embodiment of the present invention.

FIG. 6 is a flow diagram illustrating a method for enabling a mobile feature on a land line element in accordance with the preferred embodiments of the present invention.

### DETAILED DESCRIPTION OF THE PREFERRED EMBODIMENTS

In accordance with the preferred embodiments of the present invention, a communication network and a method enables mobile calling features on a land line element. The communication network provides communication services to a subscriber, who accesses the communication network via an access network such as a radio access network. In particular, the communication network generally includes a home subscriber server, a services client element, and a database translation feature server. The home subscriber server includes mobile feature information associated with mobile features such as, but not limited to, a call forwarding (i.e., call forwarding unconditional, call forwarding busy, and call forwarding roaming), a time-of-day routing, a busy status, a roam status, a no-answer status, a not-pageable status, and a not-reachable status. The mobile feature information may include, but is not limited to, a phone number, an electronic mail address, an Internet Protocol (IP) address, a billing rate, and a status message. The services client element receives a registration from the subscriber. The registration provides the services client element with information such as, but not limited to, the location of a mobile station used by the subscriber. The services client element retrieves mobile feature information based on the registration from the home subscriber server. The database translation feature server receives the mobile feature information from the services client element. In particular, the database translation feature server may receive the mobile feature information via a first interface such as, but not limited to, a session initiation protocol (SIP) interface and an application program interface (API). Furthermore, the database translation feature server translates the mobile feature information so that the mobile feature information may be transmitted to a land line element. For example, the mobile feature information may be transmitted via a second interface such as, but not limited to, a provisioning interface, a session initiation protocol (SIP) interface, and an H.323 interface. The land line element may include a provisioning database (i.e., a fixed or land line database) and a call agent (i.e., a softswitch). The provisioning database is updated with the mobile feature information, which in turn, is retrieved by the call agent to operate a fixed feature (i.e., the fixed feature information is substituted with the mobile feature information). As a result, a mobile feature is enabled on the land line element.

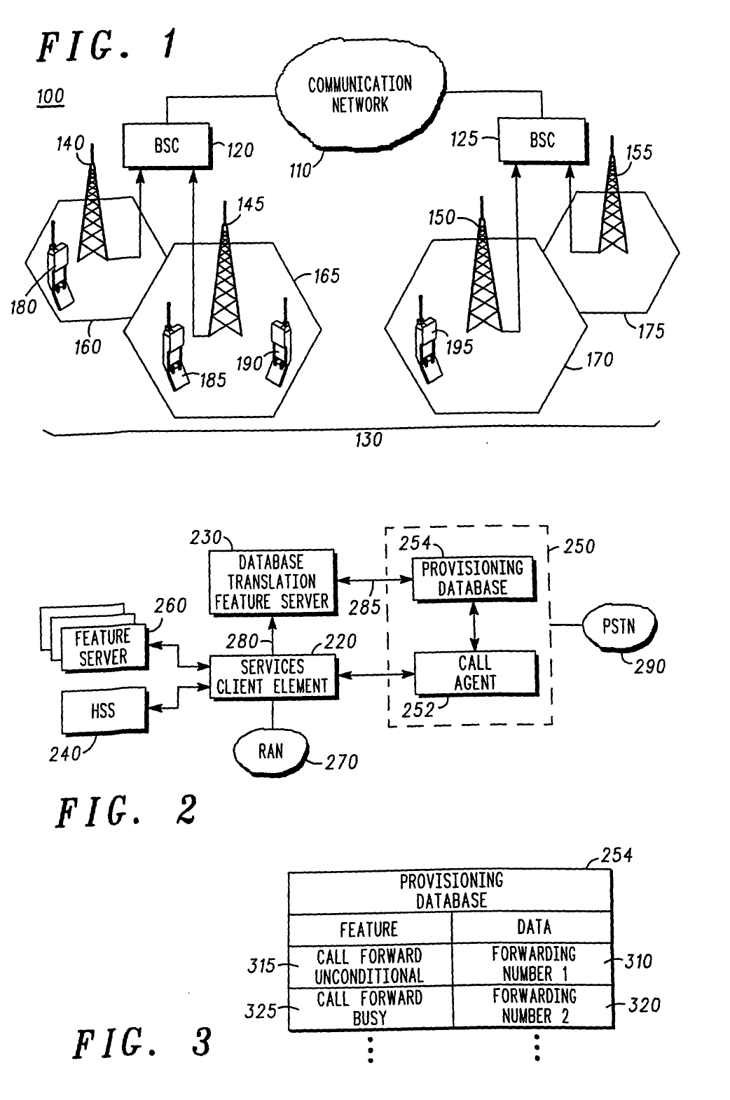

The communication network in accordance with the present invention is described in terms of several preferred embodiments, and particularly, in terms of a wireless communication system operating in accordance with at least one of several communication standards. These standards include analog, digital or dual-mode communication system protocols such as, but not limited to, the Advanced Mobile Phone System (AMPS), the Narrowband Advanced Mobile Phone System (NAMPS), the Global System for Mobile Communications (GSM), the IS-55 Time Division Multiple Access (TDMA) digital cellular, the IS-95 Code Division Multiple Access (CDMA) digital cellular, CDMA 2000, the Personal Communications System (PCS), 3G and variations and evolutions of these protocols. As shown in FIG. 1, a wireless communication system 100 includes a communication network 110, a plurality of base station controllers (BSC), generally shown as 120 and 125, servicing a total service area 130. The wireless communication system 100 may be, but is not limited to, a frequency division multiple access (FDMA) based communication system, a time division multiple access (TDMA) based communication system, and a code division multiple access (CDMA) based communication system. As is known for such systems, each BSC 120 and 125 has associated therewith a plurality of base stations (BS), generally shown as 140, 145, 150, and 155, servicing communication cells, generally shown as 160, 165, 170, and 175, within the total service area 130. The BSCs 120 and 125, and base stations 140, 145, 150, and 155 are specified and operate in accordance with the applicable standard or standards for providing wireless communication services to mobile stations (MS), generally shown as 180, 185, 190, and 195, operating in communication cells 160, 165, 170, and 175, and each of these elements are commercially available from Motorola, Inc. of Schaumburg, Ill.

Referring to FIG. 2, the communication network 110 generally includes a services client element 220, a database translation feature server 230, and a home subscriber server 240. The services client element 220 is coupled for communication with the home subscriber server 240, a land line element 250, other feature servers 260, and an access network 270, which may be, but is not limited to, a radio access network including the base station controllers 120, 125, the base stations 140, 145, 150, 155, and the mobile stations 180, 185, 190, 195 mentioned above. The database translation feature server 230 is coupled for communication with the services client element 220. For example, the database translation feature server may be coupled to the services client element 220 via a first interface 280 such as, but not limited to, a session initiation protocol (SIP) interface and an application program interface (API). The database translation feature server 230 is further coupled for communication with the land line element 250. In particular, the database translation feature server 230 may be coupled to the land line element 250 via a second interface 285 such as, but not limited to, a provisioning interface, a session initiation protocol (SIP) interface, and an H.323 interface. The land line element 250 generally includes a call agent 252 (e.g., Voice over IP (VoIP) Call Agent and VoIP H.323 Gatekeeper) and a provisioning database 254. Furthermore, the land line element 250 is coupled for communication with the public switching telephone network (PSTN) 290.

A basic flow for enabling a mobile feature on the land line element 250 that may be applied with the preferred embodiment of the present invention shown in FIG. 2 may start with a subscriber registering with the services client element 220. The subscriber accesses the services client element 220 via the radio access network 270 to send a registration which may include, but is not limited to, information associated with the location of a mobile station (e.g., mobile station 180 of FIG. 1) used by the subscriber. The services client element 220 retrieves mobile feature information based on the registration. For example, the registration may indicate that the mobile station 180 is no longer within its home network (i.e., roaming). Accordingly, the services client element 220 retrieves mobile feature information based on the mobile station 180 being outside its home network. The home subscriber server 240 provides mobile feature information based on the registration to the services client element 220, which in turn, transmits the mobile feature information to the database translation feature server 230 via the first interface 280. In particular, the mobile feature information may be, but is not limited to, a phone number, an electronic mail address, an Internet Protocol (IP) address, a billing rate, and a status message. The database translation feature server 230 is operable to translate the mobile feature information and to transmit the mobile feature information to the land line element 250 via the second interface 285. Accordingly, the provisioning database 254 is updated with the mobile feature information from the database translation feature server 230. As a result, the call agent 252 may operate fixed features based on the mobile feature information stored in the provisioning database 254.

Typically, the call agent 252 accesses the provisioning database 254 for fixed feature information to operate fixed features such as, for example, call forward unconditional and call forward busy. Referring to FIG. 3, the provisioning database 254 stores fixed feature information associated with fixed features, which may be provided by the call agent 252. In particular, the provisioning database 254 includes, but is not limited to, a forwarding number 1 310 for the fixed feature of call forward unconditional 315 and a forwarding number 2 320 for the fixed feature of call forward busy 325 for a mobile station (e.g., mobile station 180) used by a subscriber. For example, the call agent 252 may forward all calls to the forwarding number 1 310 regardless of the status of the mobile station 180. Furthermore, the call agent 252 may forward all calls to the forwarding number 2 320 when the mobile station 180 is busy regardless whether the mobile station 180 is registered within its home network.

As shown in FIG. 4, the home subscriber server 240 stores mobile feature information associated with mobile features provided by the services client element 220. In particular, the home subscriber server 240 includes, but is not limited to, a mobile forwarding number 1 410 for the mobile feature of call forward unconditional 415, a mobile forwarding number 2 420 for the mobile feature of call forward busy, no roaming 425, and a mobile forwarding number 3 430 for the mobile feature of call forward busy, roaming 435 for the mobile station 180. As noted above, the provisioning database 254 may be updated with mobile feature information provided by the database translation feature server 230. For example, the services client element 220 receives a registration from the mobile station 180. The registration indicates that the mobile station 180 is roaming (i.e., the mobile station 180 is not registered in its home network). The services client element 220 retrieves mobile feature information based on the registration. For example, the services client element 220 retrieves mobile feature information including the mobile forwarding number 3 430 from the home subscriber server 240 and transmits the mobile feature information to the database translation feature server 230 via the first interface 280. Accordingly, the database translation feature server 230 translates the mobile feature information including the mobile forwarding number 3 430 and transmits the mobile feature information to the provisioning database 254 via the second interface 285. As a result, the call agent 252 may retrieve mobile feature information that includes mobile forwarding number 3 430 to operate the fixed feature of call forward busy when the mobile station 180 roams from its home network rather than using the forward number 2 320 shown in FIG. 3. Therefore, the call agent 252 is enabled to operate the mobile feature of call forward busy, roaming for the mobile station 180.

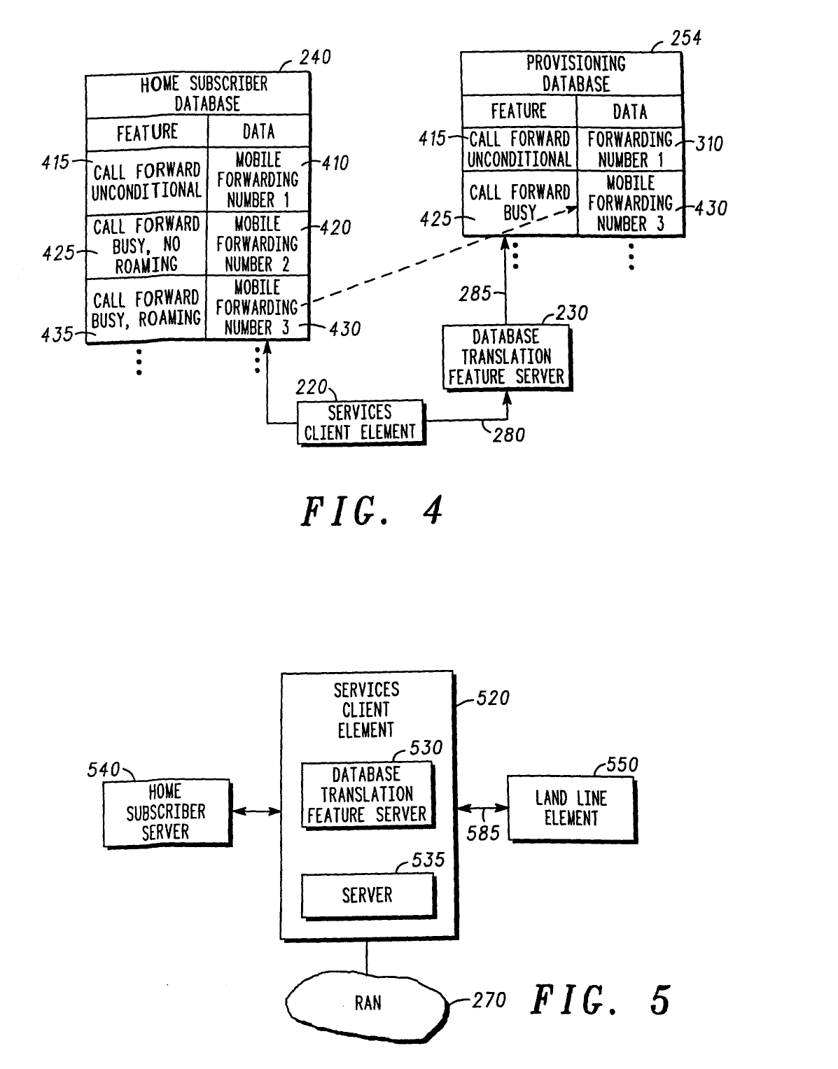

In an alternate embodiment, the database translation feature server 230 may be integrated into the services client element 220. Referring to FIG. 5, a services client element 520 generally includes a database translation feature server 530 and a server 535. The services client element 520 is interfaced with a home subscriber server 540 and a land line element 550. In particular, the services client element 520 may be coupled for communication with the land line element 550 via an interface 585 such as, but not limited to, a provisioning interface, a session initiation protocol (SIP) interface, and an H.323 interface. The server 535 executes a program or a set of operating instructions such that the services client element 520 operates in accordance with a preferred embodiment of the invention. The program or the set of operating instructions may be embodied in a computer-readable medium such as, but not limited to, paper, a programmable gate array, application specific integrated circuit, erasable programmable read only memory, read only memory, random access memory, magnetic media, and optical media. In particular, the server 535 directs the services client element 520 to retrieve mobile feature information from the home subscriber server 540. The mobile feature information is based on a registration, which may include information such as the location of the mobile station registering with the services client element 520. Accordingly, the services client element 520 translates the mobile feature information and transmits the translated mobile feature information to the land line element 550 via the interface 585. As a result, the mobile feature associated with the translated mobile feature information is enabled on the land line element 550.

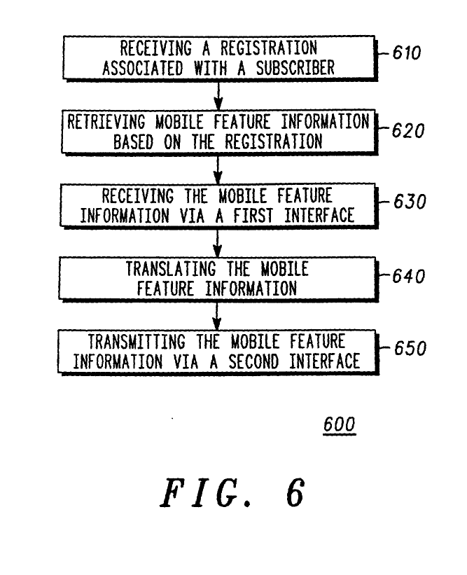

In accordance with the preferred embodiments of the present invention, and with references to FIG. 6, a method 600 for enabling a mobile feature on a land line element is shown. Method 600 begins at step 610, where a services client element receives a registration associated with a subscriber. In particular, the registration may include, but is not limited to, information such as the location of a mobile station used by the subscriber. At step 620, the services client element retrieves mobile feature information based on the registration. At step 630, the database translation feature server receives the mobile feature information from the services client element via a first interface. Accordingly, the database translation feature server translates the mobile feature information at step 640. At step 650, the database translation feature server transmits the mobile feature information to a land line element via a second interface. As a result, a provisioning database associated with the land line element is updated with mobile feature information for a fixed feature. Therefore, a mobile feature is enabled on the land line element when the land line element retrieves mobile feature information from the provisioning database.

Many changes and modifications could be made to the invention without departing from the fair scope and spirit thereof. The scope of some changes is discussed above. The scope of others will become apparent from the appended claims.

What is claimed:

1. A method for providing mobile feature information to enable a mobile feature on a land line element within a communication network, the communication network providing communication services for a subscriber, wherein the communication network includes a services client element being operable to retrieve mobile feature information based on a registration associated with the subscriber, and wherein the subscriber accesses the communication network via an access network, the method comprising:
receiving mobile feature information from the services client element;
translating the mobile feature information; and
transmitting the mobile feature information to the land line element via a second interface,
wherein the mobile feature information is associated with the mobile feature.

2. The method of claim 1, wherein the step of receiving mobile feature information from the services client element comprises receiving mobile feature information from the services client element based on information associated with location of a mobile station the subscriber.

3. The method of claim 1, wherein the step of receiving mobile feature information from the services client element comprises receiving mobile feature information from the services client element via a first interface, and wherein the first interface comprises one of a session initiation protocol (SIP) interface and an application program interface (API).

4. The method of claim 1, wherein the step of receiving mobile feature information from the services client element comprises receiving one of a phone number, an electronic mail address, an Internet Protocol (IP) address, a billing rate, and a status message from the services client element.

5. The method of claim 1, wherein the step of transmitting the mobile feature information to the land line element comprises transmitting the mobile feature information to one of a provisioning database and a call agent.

6. The method of claim 1, wherein the step of transmitting the mobile feature information to the land line element comprises transmitting the mobile feature information to the land line element via a second interface, and wherein the second interface comprises one of a provisioning interface, a session initiation protocol (SIP) interface, and an H.323 interface.

7. The method of claim 1, wherein the access network comprises a radio access network.

8. A method for enabling a mobile feature on a land line element within a communication network, the communication network providing communication services for a subscriber, wherein the subscriber accesses the communication network via an access network, the method comprising:
receiving a registration associated with the subscriber;
retrieving mobile feature information based on the registration;
translating the mobile feature information; and
transmitting the mobile feature information to the land line element.

9. The method of claim 8, wherein the step of retrieving mobile feature information based on the registration comprises retrieving mobile feature information based on information associated with location of a mobile station used by the subscriber.

10. The method of claim 8, wherein the step of retrieving mobile feature information based on the registration comprises retrieving one of a phone number, an electronic mail address, an Internet Protocol (IP) address, a billing rate, and a status message based on the registration.

11. The method of claim 8, wherein the step of transmitting the mobile feature information to the land line element comprises transmitting the mobile feature information to one of a provisioning database and a call agent.

12. The method of claim 8, wherein the step of transmitting the mobile feature information to the land line element via an interface comprises transmitting the mobile feature information to the land line element via one of a provisioning interface, a session initiation protocol (SIP) interface, and an H.323 interface.

13. The method of claim 8, wherein the access network comprises a radio access network.

14. A communication network for providing communication services for a subscriber, the communication network being operable to enable a mobile feature on a land line element, wherein the subscriber accesses the communication network via an access network, the communication network comprising:
a home subscriber server;
a services client element coupled for communication with the home subscriber server, the services client element being operable to retrieve mobile feature information based on a registration associated with the subscriber; and
a database translation feature server coupled for communication with the services client element, the database translation feature server being operable to translate the mobile feature information from the services client element,
wherein the database translation feature server transmits the mobile feature information to a land line element.

15. The communication network of claim 14, wherein the registration comprises information associated with location of a mobile station the subscriber.

16. The communication network of claim 14, wherein the land line element comprises one of a provisioning database and a call agent.

17. The communication network of claim 14, wherein the database translation feature server is coupled for communication with the services client element via a first interface, and wherein the first interface comprises one of a session initiation protocol (SIP) interface and an application program interface (API).

18. The communication network of claim 14, wherein the database translation feature server is coupled for communication with the land line element via a second interface, and wherein the second interface comprises one of a provisioning interface, a session initiation protocol (SIP) interface, and an H.323 interface.

19. The communication network of claim 14, wherein the mobile feature information comprises one of a phone number, an electronic mail address, an Internet Protocol (IP) address, a billing rate, and a status message.

20. The communication network of claim 14, wherein the database translation feature server is integrated into the services client element.

21. The communication network of claim 14, wherein the access network comprises a radio access network.

22. In a communication network for providing communication services for a subscriber, the subscriber accesses the communication network via an access network, wherein the communication network includes a services client element being operable to retrieve mobile feature information based on a registration associated with the subscriber, and wherein a server operates in accordance to a computer program embodied on a computer-readable medium for enabling a mobile feature on a land line element, the computer program comprising:
a first routine that directs the server to receive mobile feature information from the services client element;
a second routine that directs the server to translate the mobile feature information; and
a third routine that directs the server to transmit the mobile feature information to the land line element.

23. The computer program of claim 22, wherein the first routine comprises a routine that directs the server to receive mobile feature information from the services client element based on information associated with location of a mobile station used the subscriber.

24. The computer program of claim 22, wherein the first routine comprises a routine that directs the server to receive one of a phone number, an electronic mail address, an Internet Protocol (IP) address, a billing rate, and a status message from the services client element.

25. The computer program of claim 22, wherein the first routine comprises a routine that directs the server to receive mobile feature information from the services client element via a first interface, and wherein the first interface comprises one of a session initiation protocol (SIP) interface and an application program interface (API).

26. The computer program of claim 22, wherein the first routine receives a registration and obtains the mobile feature information based the registration.

27. The computer program of claim 22, wherein the second routine comprises a routine that directs the server to transmit the mobile feature information to the land line element via a second interface, and wherein the second interface comprises one of a provisioning interface, a session initiation protocol (SIP) interface, and an H.323 interface.

28. The computer program of claim 22, wherein the third routine comprises a routine that directs the server to transmit the mobile feature information to one of a provisioning database and a call agent.

29. The computer program of claim 22, wherein the access network comprises a radio access network.

30. The computer program of claim 22, wherein the medium comprises one of paper, a programmable gate array, application specific integrated circuit, erasable programmable read only memory, read only memory, random access memory, magnetic media, and optical media.
